(19) United States
(12) Patent Application Publication
(10) Pub. No.: US 2025/0353046 A1
(43) Pub. Date: Nov. 20, 2025

(54) MODIFYING SURFACES WITH AN ATMOSPHERIC PRESSURE PLASMA

(71) Applicant: Surfx Technologies LLC, Redondo Beach, CA (US)

(72) Inventors: Sepehrdod Tom Saremi, Gardena, CA (US); Hsiao-Wen Liu, Taichung City (TW); Thomas Scott Williams, Long Beach, CA (US); Robert F. Hicks, Los Angeles, CA (US)

(73) Assignee: Surfx Technologies LLC, Redondo Beach, CA (US)

(21) Appl. No.: 18/666,256

(22) Filed: May 16, 2024

(51) Int. Cl. B08B 7/00; C03C 23/00; H05H 1/30

(52) U.S. Cl. CPC B08B 7/0035; C03C 23/006; C03C 23/0075; H05H 1/30; H05H 2245/42

(57) ABSTRACT

A method for treating a surface of a material at atmospheric pressure comprises providing an atmospheric pressure argon plasma source capable of delivering a beam comprising a reactive gas from the source outlet, applying radio frequency (RF) power to the atmospheric pressure argon plasma source for generating the reactive gas in the beam from the source outlet, and translating the atmospheric pressure argon plasma source relative to the material at a distance from the source outlet to said surface close enough for the reactive gas from the atmospheric pressure argon plasma source to contact and treat the surface. Importantly, the beam of the reactive gas at the source outlet comprises a power density of at least 100 W/mm.

### BACKGROUND OF THE INVENTION

### 1. Field of the Invention

The present disclosure is related to methods for modifying material surfaces using a high-power plasma device that produces a narrow-diameter reactive gas beam. In particular, the present disclosure is related to specific combinations of factors allowing for high-speed modification of materials using a high-power plasma device producing a narrow-diameter reactive gas beam at atmospheric pressure.

### 2. Description of Related Art

Ionized gas plasmas have found wide application in materials processing. Plasmas that are used in materials processing are generally weakly ionized, meaning that a small fraction of the molecules in the gas are charged. In addition to the ions, these plasmas contain reactive species that can modify surfaces by cleaning, activating, etching material, and depositing material onto said surfaces. The physics and chemistry of weakly ionized plasmas are described in several textbooks. See, for example, Lieberman and Lichtenberg, “Principles of Plasma Discharges and Materials Processing,” (John Wiley & Sons, Inc., New York, 2005); F. F. Chen and J. P. Chang, “Lecture Notes on Principles of Plasma Processing,” (Kluwer Academic/Plenum Publishers, New York, 2003); and Raizer, Y. P., “Gas Discharge Physics,” (Springer-Verglag, Berlin (1991).

According to the literature, weakly ionized plasmas are generated in vacuum at pressures between 0.001 and 1.0 Torr (see Lieberman and Lichtenberg (2005)). Electrical power is applied across two electrodes to break the gas down and ionize it. The electricity may be provided by applying direct current (DC), alternating current (AC), radio frequency power (RF), or microwave power (MW). In the case of RF power, the electrode may be constructed to provide either capacitive or inductive coupling to strike and maintain the plasma. In capacitive coupling, two conducting electrodes are placed inside the vacuum chamber filled with gas at 50 to 1,000 milliTorr. One of the electrodes is powered, or biased, by the RF generator, while the other one is grounded. In inductive coupling, the RF power is supplied through an antenna that is wrapped in a coil around the insulating walls of the chamber. The oscillating electric field from the coil penetrates into the gas inducing ionization.

Atmospheric pressure plasmas have been developed as an alternative to vacuum plasmas. These plasmas can treat an object of any size and shape since they do not have to be loaded inside a chamber. This can significantly reduce the cost of the process. Moreover, atmospheric pressure plasmas enable the in-line processing of materials (instead of batch processing) with the advantage of “just-in-time” modification of the substrate prior to the next step in the manufacturing operation. A number of different atmospheric pressure plasma devices have been developed (see for example: Winter, et al., “Atmospheric pressure plasma jets: an overview of devices and new directions,” Plasma Sources Science and Technology, vol. 24.6, p. 064001 (2015); Tendero, et al., “Atmospheric pressure plasmas: A review,” Spectrochimica Acta Part B: Atomic Spectro., vol 61.1, p. 2 (2006); and Schutze, et. al., “The atmospheric-pressure plasma jet: A review and comparison to other plasma sources,” IEEE Trans. Plasma Sci. 26, 1685-1694 (1998)). These plasmas are governed by how the ionization process is controlled. At atmospheric pressure, the gas density is so high that the ionization reaction can easily run away and generate a high temperature arc, with the potential for electrically or thermally damaging the materials being processed. In this regard, it is beneficial to control the ionization reaction so that it does not run away, and instead produces a weakly ionized plasma (Raizer, Y. P., “Gas Discharge Physics,” (Springer-Verglag, Berlin (1991).

Three common types of atmospheric pressure plasmas exist that are used to modify material surfaces. These include a dielectric barrier discharge (DBD), a torch or arc, and a radio frequency, noble-gas discharge. The DBD has long been employed to treat rolls of plastic film, whereby the polymer sheet is continuously passed between the electrodes. In some instances, the DBD may be deployed as a downstream device, so that 3-D objects can be treated with the reactive gasses that flow out from between the electrodes. The torch and the RF noble-gas discharge are strictly downstream plasmas. In the case of the torch, air is fed through an arc generated by applying high voltage AC power inside the device. The resultant plasma is blown out the end of the torch by applying a high gas velocity.

In contrast to the plasma torch, the noble-gas discharge is fed with helium or argon and a few percent of molecular gas, such as oxygen. Application of RF power generates a weakly ionized plasma at a low temperature, generally less than 250oC. The plasma generated in this source exhibits a free electron concentration less than 150 parts per billion, i.e., less than 3.0×1012 electrons per centimeter cubed of gas volume at atmospheric pressure (see for example, Moravej, et al., in “Physics of High-Pressure Helium and Argon Radio-Frequency Plasmas,” J. Appl. Phys., vol. 96, p. 7011 (2004). The concentration of reactive gas species generated in the exit beam of these plasma sources can be on the order of 1.0% (Moravej, et al., in “A radio frequency nonequilibrium atmospheric pressure plasma operating with argon and oxygen,” J. Appl. Phys., vol. 99, p. 093305-1 (2006)). Such a concentration of reactive species is suitable for modification of material surfaces.

Reactive species generated in the noble-gas discharge flow out of the device in a laminar jet at a much lower gas velocity than the torch. The ions and electrons generated within the plasma are confined to the gap between the electrodes, so that a beam of neutral reactive species, stripped of ions and electrons, exits the source in the laminar gas jet. Usually, a robot is used to scan the reactive gas beam over a substrate that is positioned a few centimeters or less below the exit of the plasma device. In contrast to vacuum plasmas, only the area on the sample surface requiring modification is exposed to the reactive species.

Selwyn discloses in U.S. Pat. No. 5,961,772 an atmospheric pressure plasma jet (APPJ) that consists of two concentric cylinders where the inner cylinder is driven with radio frequency power at 13.56 megahertz (MHz) and the outer cylinder is grounded. Helium gas and 1.0 to 6.0% oxygen flows between the cylinders and is ionized by application of the RF power. Reactive oxygen species flow out of a circular hole, 6.4 mm (0.25 inches) in diameter, in the end of the plasma source. These species are shown to etch through a Kapton film placed downstream of the plasma jet at a rate of 13.0 microns per minute (Um/min) using an applied RF power of 300 W. The power density, defined as the Watts per width of the exit plasma beam, is 300 W divided by 6.4 mm equals 46.9 W/mm.

Babayan and Hicks disclose in U.S. Pat. No. 8,328,982, low-temperature, atmospheric pressure plasma devices that have a converging gas flow, where the plasma exits out a spot to produce a small circular plasma beam, or out a slit to produce a linear plasma beam. These devices are fed with helium and 1.0 to 2.0 volume % oxygen, and the plasma is struck and maintained with an RF power at 27.12 MHz and 250 to 270 W. Examples of surface activation, Kapton etching, and thin film deposition are provided in the patent. In particular, a Kapton etch rate of 168 microns per minute was reported for plasma operating conditions of 30 liters/minute (LPM) helium, 2.0 LPM oxygen and 270 W. The activation of polymer surfaces was shown by scanning the plasma beam over the substrate at 6.0 to 25.0 mm/s and observing an increase in the surface energy from between 30 and 46 dyne/cm to greater than 70 dyne/cm.

Cheng, et. al., in U.S. Pat. No. 9,406,485 disclose of a low-temperature, atmospheric pressure plasma apparatus that is fed with argon and 1.0 to 5.0% molecular gases (O2, N2, H2, etc.), and is driven with RF power. In this device, the powered and grounded electrodes are heated. Examples are provided of cleaning substrates, surface activation, etching substrates, and depositing thin films. A Kapton etch rate of 54 □m/min was observed across a 25-mm-wide plasma beam, with the device operated at 180 W, 15 LPM argon flow and 6.8% oxygen. Polymer surfaces were activated by scanning the plasma beam over the substrate surface at 10 to 200 millimeters per second (mm/s). The activation of the surface was determined by measuring the water contact angle. A contact angle of 90o was indicative of a non-active, hydrophobic surface, whereas a contact angle of less than 30o was indicative of an activated, hydrophilic surface. It was reported that the glass surface on a silicon wafer is fully activated with a water contact angle of 100 or less by scanning the wafer at 50 mm/s. The plasma device with a 25 mm (1.0 inch) wide beam was operated at 100 W, 15.0 LPM argon and 0.25 LPM oxygen. Scaling the RF power per unit width of the plasma beam yields a value of 4.0 W/mm. The device exit was kept at a distance of 4 mm from the substrate surface.

Various sizes of plasma heads have been used commercially, taking advantage of the properties of the low-temperature, atmospheric pressure, noble-gas plasma. One such device is the SPS-100 supplied by Surfx Technologies, LLC, which provides a reactive gas beam across a slit width of 100 mm (4.0 inches). This plasma is driven with radio frequency power at 27.12 MHz and is fed with 99.0% argon and approximately 1.0% molecular gases, such as oxygen or hydrogen.

Another such commercial atmospheric-pressure plasma is a small spot source, the SPS-M, provided by Surfx Technologies, LLC. The reactive gas beam from this device exits from a hole that is one to two millimeters in diameter. The gas beam impinges on a material located a short distance downstream, e.g., 0.1 to 3.0 centimeters. In order to treat a well-defined surface area of the material the spot plasma source is translated across the surface at a fixed speed. The SPS-M is driven with RF power at 27.12 MHz and fed with 99% argon and 1% of a molecular gas.

The operating window of the atmospheric pressure, argon plasma source with the 100 mm wide plasma beam (e.g., the SPS-100), is between 300 and 600 W of RF power, i.e., with a plasma density of 3 to 6 W per mm of beam width. Higher power levels than this causes the plasma to transition into an arc, with it collapsing into a small bright spot at one position between the powered and grounded electrodes. In the case of the spot plasma source (e.g., the SPS-M), the applied RF power is varied between 50 and 150 W to limit the potential for arcing. With a plasma beam diameter at the device exit of 2 mm, these power levels correspond to a plasma density between 25 and 75 W/mm. A drawback of using this range of RF powers in the spot source, however, is that it increases the time required to clean and activate surfaces, making the device less economically advantageous to use in materials manufacturing.

### SUMMARY OF THE INVENTION

A method for using a spot plasma source has been developed to modify material surfaces. This device is well suited for high-volume manufacturing of technologically significant products, such as for example, electronics, semiconductor devices, medical devices, and medical diagnostics.

Previous research and development on low-temperature, atmospheric pressure argon plasmas have taught that the appropriate range of RF power is between 50 and 150 W for a spot source, corresponding to a plasma density of 25 to 75 W/mm. Higher power levels were thought to lead to arcing of the plasma source which would damage the device, and potentially cause thermal damage to the substrate as well. Operating at such power densities, however, limits the rate of surface modification, and negatively impacts the economic benefit of the materials process.

After much experimentation, embodiments herein are shown to significantly reduce the time required for surface modification, thereby providing a more economically viable process for treating materials. Disclosed herein are systems and methods for providing a small spot, atmospheric-pressure argon plasma at high power densities, i.e. 100 W/mm or greater (e.g., ideally in a range of 100 to 500 W/mm, where the input power in Watts is divided by the diameter of the exit hole of the plasma source in millimeters). Various embodiments include argon and oxygen plasma recipes for surface activation of aluminum, silicon dies, and epoxy mold compound. In other embodiments, argon and hydrogen plasma recipes are used to etch away copper oxide on copper films.

An exemplary embodiment of the invention comprises a method for treating a surface of a material at atmospheric pressure including providing an atmospheric pressure argon plasma source capable of delivering a beam comprising a reactive gas from the source outlet, applying radio frequency (RF) power to the atmospheric pressure argon plasma source for generating the reactive gas in the beam from the source outlet, and translating the atmospheric pressure argon plasma source relative to the material at a distance from the source outlet to said surface close enough for the reactive gas from the atmospheric pressure argon plasma source to contact and treat the surface. The beam of the reactive gas at the source outlet comprises a power density of at least 100 W/mm. This lineal power density exceeds known prior art applications of low temperature, atmospheric pressure plasma which was previously believed would breakdown at such power densities. This method can be further modified consistent with any other embodiment described herein. Typically, the RF power has a frequency that is an integer multiple of 13.56 MHz. For example, the RF power can be provided at 27.12 MHz.

In further embodiments, the source outlet can be a circular hole with a diameter between 0.5 and 2.5 mm. The RF power can be at least 200 W. In some embodiments, the atmospheric pressure argon plasma source can generate the beam from a gas flow comprising argon and a molecular gas at a flow rate between 5 and 50 liters per minute. The gas flow can further comprise argon and 1% of a molecular gas including molecules of O, N, and H. In some embodiments, the gas flow can further comprise argon and 1% of a molecular gas from the group consisting of oxygen (O₂), nitrogen (N₂), hydrogen (H₂) and mixtures thereof.

In some embodiments, translating the atmospheric pressure argon plasma source relative to the material can be performed at a translation speed from 0 to 1,000 mm/s. The distance from the source outlet to the material surface can be 0.5 to 25.0 mm.

In further embodiments, the material can comprise one of a metal substrate, a semiconductor substrate, or a polymer substrate and contacting and treating the surface with the reactive gas from the atmospheric pressure argon plasma source comprises a material modification of the surface. The material modification can be selected from the group consisting of cleaning, organic contamination removal, activation for adhesion improvement, etching, and metal oxide removal. The material surface can comprise an organic polymer and the surface can be cleaned and activated for adhesion by exposure to the atmospheric pressure argon plasma source fed with argon and oxygen. The material surface can comprise glass and the surface can be cleaned and activated by exposure to the atmospheric pressure argon plasma source fed with argon and oxygen. The material can comprise an organic polymer and the organic polymer can be etched away by exposure to the atmospheric pressure argon plasma source fed with argon and oxygen. The material can comprise a metal and an oxide layer on the surface of the metal can be removed by exposure to the atmospheric pressure argon plasma source fed with argon and hydrogen. The metal can be selected from the group consisting of copper, tin, indium, silver, platinum, palladium, gold and mixtures thereof.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a perspective view of an example of a spot plasma source operating at low temperature and atmospheric pressure and operated with RF power, argon gas flow and a molecular gas (e.g., oxygen, nitrogen, or hydrogen);

FIG. 2 is a schematic representation of an apparatus for modifying a material using a spot plasma source operated at low temperature and atmospheric pressure;

FIG. 3 is a flowchart for a method of modifying the surface of a material using a spot plasma source operating at low temperature, atmospheric pressure, and fed with argon and oxygen according to one or more embodiments of the invention;

FIG. 4 is a plot of the water contact angle of Kapton as a function of the distance from the center of the reactive gas beam as the spot source is translated over the polymer sample at a speed of 100 mm/s and a source-to-sample distance of 4 mm;

FIG. 5 is a bar graph illustrating the activation of an aluminum surface with the spot plasma source as observed by changes in the water contact angle (WCA), surface free energy (SFE) and polar component of the surface free energy;

FIG. 6 is a bar graph illustrating the activation of a silicon die with the spot plasma source as observed by changes in the water contact angle (WCA), surface free energy (SFE) and polar component of the surface free energy;

FIG. 7 is a bar graph illustrating the activation of epoxy mold with the spot plasma source as observed by changes in the water contact angle (WCA), surface free energy (SFE) and polar component of the surface free energy; and

FIG. 8 is a picture of a copper film on a silicon substrate after etching away the copper oxide surface layer with the spot plasma source at atmospheric pressure, 150° C., 120 mm/s scan speed and a source-to-sample distance of 1.0 mm.

### DETAILED DESCRIPTION INCLUDING THE PREFERRED EMBODIMENTS

As described above, methods for activating a variety of materials are disclosed using argon and oxygen, or argon and hydrogen. The systems and methods can be used to optimize production of preferred plasma species in a given system. As used in this specification, the singular forms “a” “an” and “the” include plural referents unless the context clearly dictates otherwise. Thus, for example, the term “a processor,” or any other network-related component recited, is intended to mean one or more of that component, or a combination thereof.

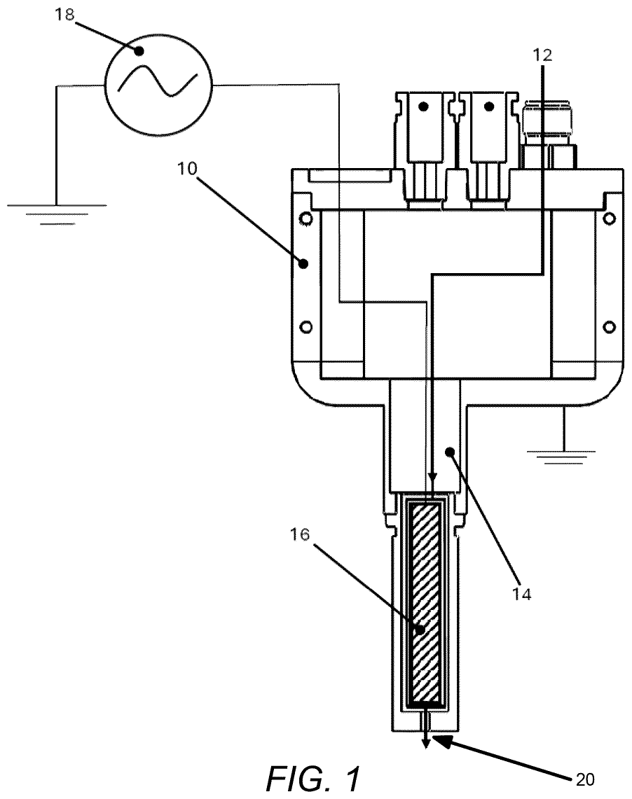

FIG. 1 is a perspective view of an example of a spot plasma source that can be used to modify a small area of a material surface. i.e., a spot with a substantially circular cross section having a diameter of 1 to 15 mm, according to an embodiment. For the purposes of the present disclosure, the term “modification” of a surface is used to mean cleaning and/or activating the surface, etching a thin film, and depositing a thin film, as context permits, according to the disclosed embodiments. One skilled in the art will appreciate that, in the embodiments disclosed herein, the beam diameter measurement is taken at the surface of the material being modified.

In the plasma source in FIG. 1, the process gas (e.g., argon and oxygen, or argon and hydrogen) enters the body, 10, of the plasma source through a gas connection, 12. The gas then flows through a central hole in a spacer, 14, and into a gap formed between the powered electrode, 16, and the grounded body, 10. The process gas flows out of the exit hole, 20, in the body, 10, at the bottom. The diameter of the exit hole, 20, is from 0.5 to 2.5 mm. The electrode, 16, may be covered with a dielectric layer to help stabilize the capacitive discharge plasma. A radio frequency (RF) power supply, 18, delivers electrical power between the electrode, 16, and the body, 10. The radio frequency signal can be 13.56 MHz, 27.12 MHz, or integer multiples of 13.56 MHz, as approved by the FCC for use in materials processing. The supplied RF power ionizes the gas in the gap between the electrode, 16, and body, 10, creating a beam of reactive gas that exits the opening, 20, and impinges on the material placed downstream. In an embodiment, the plasma beam is created at atmospheric pressure with a beam diameter of 0.5 to 2.5 mm at the exit of the device, but that expands to a diameter of up to 20 mm at the substrate surface, depending on how far the plasma source is fixed above the substrate. By translating the plasma beam over the sample, a line of surface modification is created with a line width of 1 to 20 mm, again depending on how far the plasma source is from the substrate.

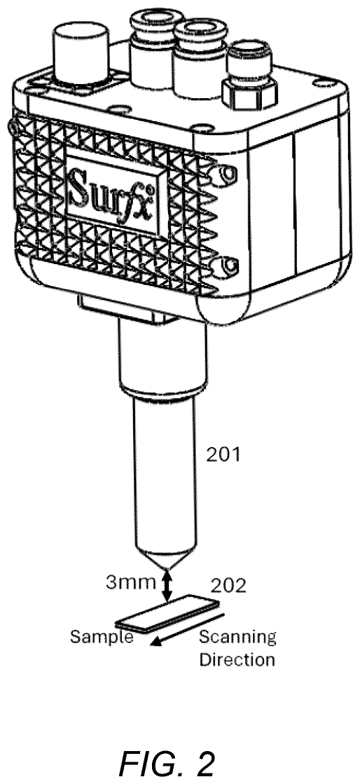

FIG. 2 is a schematic representation of a system for modifying a material using an argon spot plasma source under atmospheric pressure. In an embodiment, the plasma head, 201, is placed a distance (e.g., 3 mm) from the sample material, 202, to be modified. The plasma head, 201, is then ignited and reactive gas flows out from a 0.5 to 2.5 mm hole in the nozzle at the bottom of the head proximate to the material surface. The plasma head, 201, and sample, 202, are then translated relative to each other in a scanning direction denoted by the arrow in the figure. As the plasma head, 201, is translated over the sample, 202, the material surface undergoes modification. The speed of the surface modification (i.e., the relative speed of plasma head, 201, to sample, 202) can be varied based on the reaction chemistry of the process.

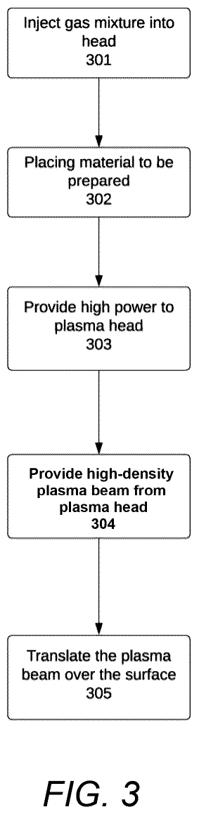

FIG. 3 is a flowchart for a method of modifying a surface using the low-temperature, atmospheric pressure plasma source, according to one or more embodiments. At 301, a gas mixture is fed into the plasma head. The gas mixture can be (or in an embodiment, can include) argon and oxygen with a concentration of 0.2 to 2.0 volume % oxygen and the remainder argon. One skilled in the art will appreciate that the system is sensitive to the amount of oxygen mixed with the argon, and so for the purposes of the present disclosure, the preferred concentration is in the range of 1.0 volume %.

At 302, the material to be modified is placed under the plasma head at a predetermined distance that can fall in the range of 1 mm to 24 mm. In an embodiment, the range can be from 1 mm to 20 mm; in an embodiment, the range can be from 1 mm to 12 mm; in an embodiment, the range can be from 3 mm to 12 mm, or any subset thereof.

At 303, RF power is supplied through an impedance matching network to the plasma head to strike and maintain the plasma inside the head. In an embodiment, the RF power is supplied in a range from 100 to 600 W; in an embodiment, the RF power is supplied in a range from 250 to 500 W.

At 304, a reactive gas beam flows out of the plasma head through a hole 0.5 to 2.5 mm in diameter, providing a high-density plasma beam of 100 to 600 W/mm for treating the surface at issue. In an embodiment, the reactive gas beam impinging on the material surface has a cross section with a diameter of from 0.5 mm to 20.0 mm, depending on how far the exit nozzle of the plasma head is from the surface. In another embodiment, the reactive gas beam impinging on the material surface has a diameter from 5.0 mm to 20.0 mm; and in an other embodiment, the plasma beam has a diameter from 10.0 mm to 15.0 mm, or any subset of the foregoing (note that 25.4 mm is equivalent to 1.0 inch).

The reactive gas beam is then translated over the material surface at a predetermined rate at 305. To translate the beam over the surface, the plasma head and the substrate are moved relative to each other. Thus, the substrate may be fixed while the plasma head is moved, the plasma head may be fixed while the substrate is moved, or both the plasma head and the substrate may be moved relative to each other. In an embodiment, the speed of the relative movement can be in a range from 0 to 1000 mm/s; in an embodiment, the speed of the relative movement can be in a range from 0 to 200 mm/s; in an embodiment, the speed can be in a range from 10 to 150 mm/s, or any subset of the foregoing.

One skilled in the art will appreciate that to achieve a certain degree of modification of a surface, such as cleaning or activating the surface, the translation speed and distance from the plasma head to the material surface are inversely correlated (i.e., the closer the substrate surface is to the plasma head, the faster the plasma head can be translated relative to the substrate. In addition, the translation speed is directly correlated with the amount of RF power supplied to the plasma head with faster speeds possible at higher power densities.

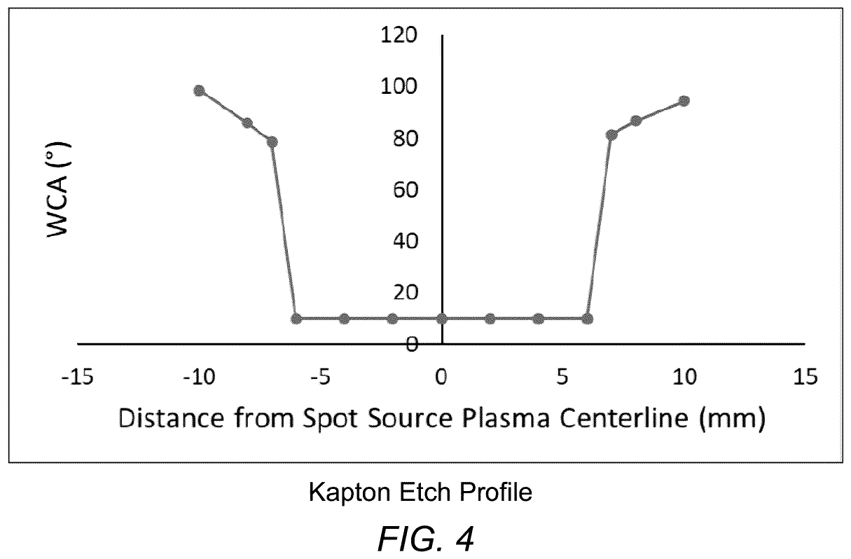

Shown in FIG. 4 is an example embodiment of the modification of a Kapton film surface by translating the spot plasma source fed with oxygen and argon over it at 100 mm/s and an offset of 4.0 mm. The exit hole in the plasma source was 2.0 mm. The plasma operating conditions were 270 W RF power (at 27.12 MHz), 10 LPM argon and 0.05 LPM oxygen. The plasma density at the exit was 135 W/mm. The graph was obtained by measuring the water contact angle at multiple points perpendicular to the direction of translation of the reactive gas beam. From 0 to 6 mm in the positive or negative direction from the beam center, the Kapton surface is fully activated, exhibiting a WCA of 10 degrees. At greater distance from the centerline, the Kapton is not activated and the WCA rises to an asymptotic value of 98 degrees. This illustrates that the reactive gas beam spreads from 1.0 mm at the device exit to 12.0 mm at the sample surface when the sample is placed 4.0 mm away. The activation of the Kapton is exceptionally fast at 100 mm/s. By contrast, Babayan and Hicks disclosed in U.S. Pat. No. 8,328,982 that the plasma in their invention required a scan speed of 6.0 to 25.0 mm/s to achieve activation of the polymer surface. The embodiment of the invention reported herein is 4 to 17 times faster.

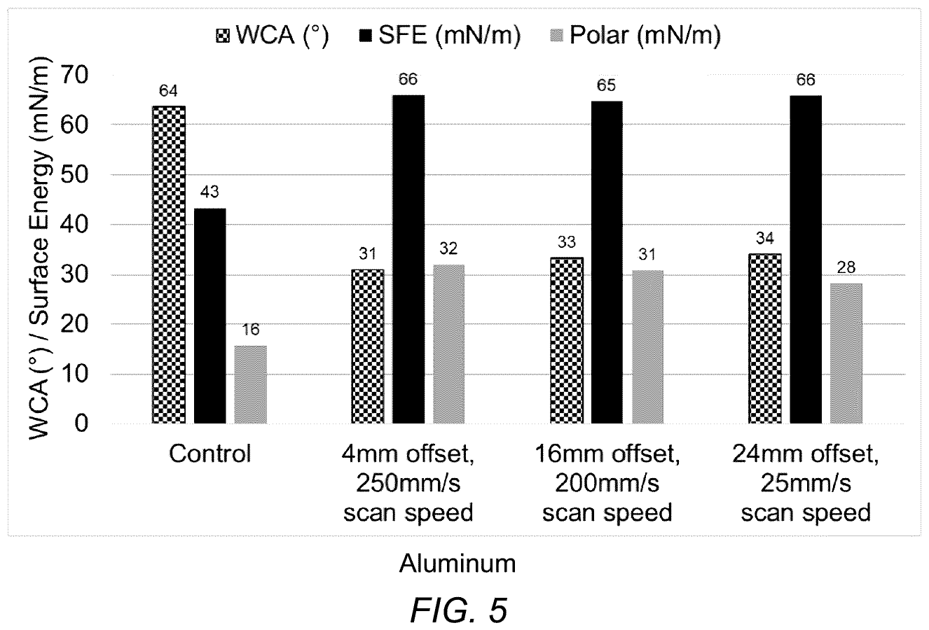

FIGS. 5, 6 and 7 illustrate various embodiments of exceptionally fast cleaning and activation of the surfaces of aluminum, silicon, and epoxy mold using a reactive gas beam produced at relatively high RF power, where the outlet from the plasma head can be as much as 25.0 mm away from the surface. Regardless of the source-to-sample distance, no thermal damage occurs on any of the materials. One skilled in the art will appreciate that the data for water contact angle (WCA), surface from energy (SFE), and polar component of the SFE are used to determine how well the surface of the material has been cleaned and activated for adhesion. Surfaces with a WCA in the range of 45° to 120° are not clean or active, whereas surfaces with a WCA below 35° are clean and active for bonding. Moreover, a surface free energy below 60 mN/m and a polar component of the SFE below 25 mN/m is indicative of a material surface that is not clean or active. By contrast, an SFE in the range of 65 to 75 mN/m and a polar component of the SFE in the range of 30 to 40 mN/m is indicative of a surface that is clean and active for bonding.

FIG. 5 shows a bar graph that illustrates embodiments above for aluminum surface modification. One skilled in the art will understand that aluminum must be cleaned and activated to facilitate the adhesion of certain glues, and a common application is bonding heatsinks to integrated circuits. As seen in FIG. 5, the aluminum surface exhibits a WCA of 64°, an SFE of 43 mN/m and a polar component of the SFE of 16 mN/m before exposure to the low temperature, atmospheric pressure. If the aluminum is treated with the spot plasma source operated at 270 W RF power, 10.0 LPM of argon, and 0.10 LPM of oxygen, with a power density of 135 W/mm at the beam exit. At a 4 mm offset distance, and a translation speed of 250 mm/s (i.e., 10.0 inches per second), the surface is fully cleaned and activated for adhesion. In this embodiment, the WCA, SFE and polar component of the SFE are 3°, 62 mN/m and 32 mN/m, respectively, after treatment. At a plasma source-to-sample distance of 16 and 24 mm, the aluminum surface is fully activated at 200 and 25 mm/s, respectively. The translation speed observed at a 4 mm offset is about ten times faster than that recorded for a similar spot plasma source, e.g., the SPS-M, operated at 150 W RF power and argon and oxygen gas flow.

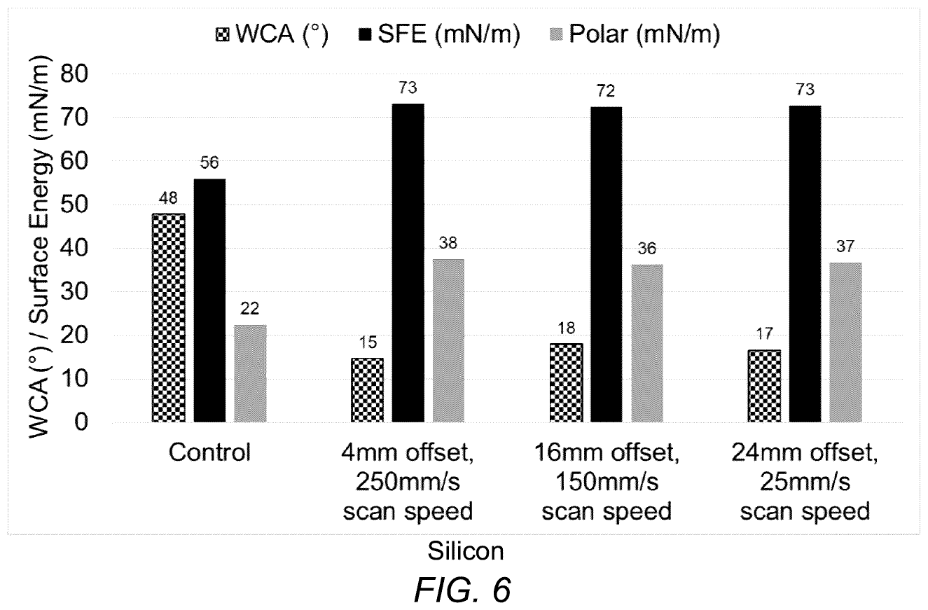

FIG. 6 shows a bar graph that illustrates embodiments for surface modification of a silicon die, i.e., an integrated circuit. The die surface is covered with a native oxide with a composition similar to glass. One skilled in the art will understand that dies must be clean and active to facilitate adhesion of the protective epoxy over-mold. Before exposure to the spot plasma, the native oxide has a WCA of 48°, an SFE of 56 mN/m, and a polar component of the SFE of 22 mN/m. The sample was exposed to the spot plasma source operated at 270 W (i.e., 135 W/mm), 10.0 LPM argon and 0.1 LPM oxygen. At a distance of 4 mm from the device to the surface and a translation speed of 250 mm/s, the glass surface is fully cleaned and activated for adhesion. In this case, the WCA decreases to 15°, while the SFE and polar component of the SFE increase to 73 and 38 mN/m, respectively. The same level of activation was observed at an offset of 16 mm and a translation speed of 150 mm/s, as well as at an offset of 24 mm and a translation speed of 25 mm/s.

Cheng, et. al., in U.S. Pat. No. 9,406,485 disclose the activation of the native oxide on a silicon wafer with a linear plasma source, having a exit beam width of 25 mm. This source, operating at 100 W, 15.0 LPM argon and 0.25 LPM oxygen, cleans and activates the glass surface at 50 mm/s. The power density of this device is only 4 W/mm. The embodiment of the spot plasma source with the higher power density of 135 W/mm, cleans and activates the glass at a five times faster translation speed. Previous operation of such devices was kept at much lower power densities to avoid arcing of the plasma source with subsequent high levels of heating and thermal damage to the source and the substrate being exposed to the exit gas.

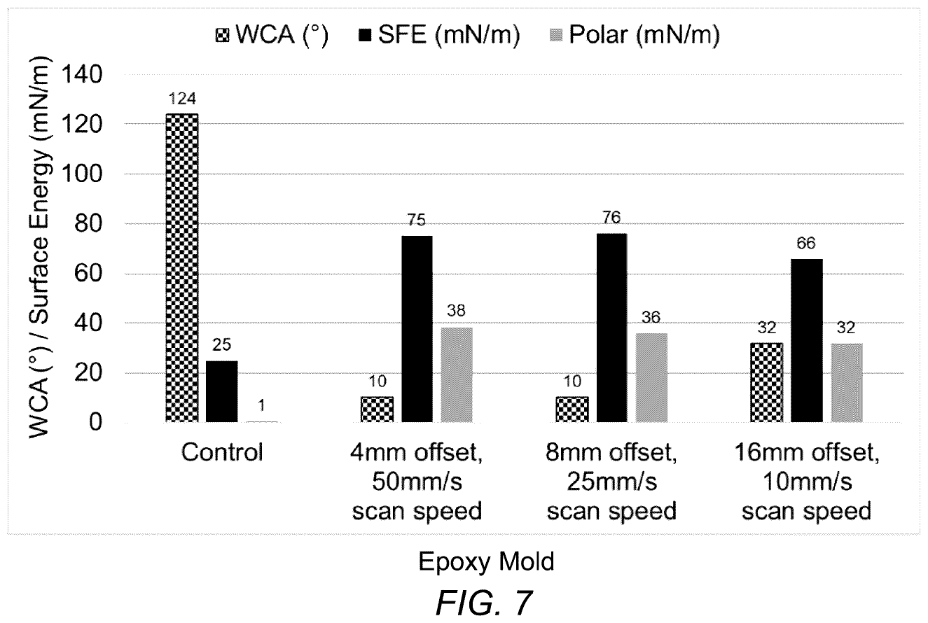

FIG. 7 presents a bar graph that illustrates embodiments for surface modification of epoxy mold compound. Epoxy over-mold on silicon dies must be cleaned and activated for adhesion prior to applying a second mold layer or prior to printing ESD protection circuits.

In FIG. 7, if 270 W RF power (i.e., 135 W/mm), 10.0 LPM of argon and 0.10 LPM of oxygen are used at a 4 mm offset distance, the epoxy is cleaned and activated at a translation speed of 50 mm/s. One sees that the WCA falls from 124° to 10°, while the surface free energy (SFE) and polar component of the SFE rise from 25 to 75 mN/m and 1 to 38 mN/m, respectively. Similar levels of activation are seen at an 8 mm offset and 25 mm/s scan speed, and at a 16 mm offset and 10 mm/s scan speed.

In embodiments, camera modules composed of anodized aluminum are treated before being glued together. At 270 W RF power (i.e., 135 W/mm), 10.0 LPM argon and 0.10 LPM oxygen, the surfaces are fully activated at 100 mm/s. Complete activation was evidenced by a surface free energy greater than 70 mN/m.

In embodiments, molded polyethylene terephthalate (plastic) is typically treated with plasma for improved bond adhesion. At 270 W RF power (i.e., 135 W/mm), 10.0 LPM argon and 0.10 LPM oxygen, complete activation is observed at a scan speed of 100 mm/s.

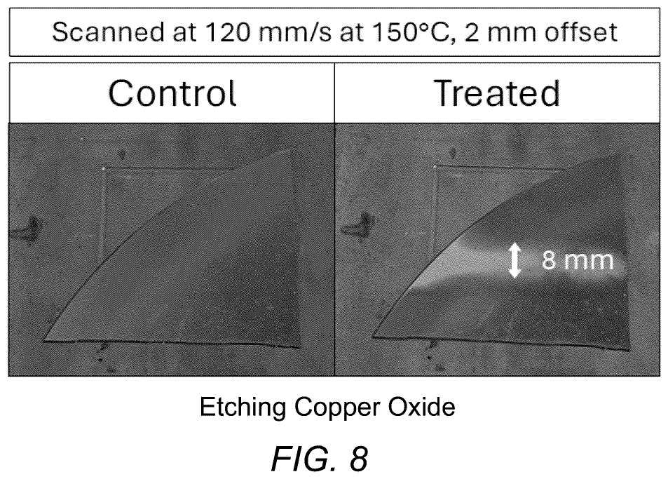

In another embodiment, copper oxide (CuO) is removed from the surface of a copper film on silicon using the spot plasma source fed with argon and hydrogen. Pictures of the copper sample before and after modification with the low-temperature, atmospheric pressure plasma is presented in FIG. 8. The spot source, with an outlet hole diameter of 2.0 mm, was operated at 500 W, 8.0 LPM argon and 3.5 LPM forming gas (a mixture of 5.0% hydrogen in argon). The plasma density at the device exit was 250 W/mm. The sample was heated on a hot plate to a temperature of 150° C., and the distance between the plasma source outlet and the surface was 2.0 mm. The CuO layer was produced by heating the sample in an oven exposed to air for 3 minutes at 150° C. This process forms a CuO layer approximately 40 nm thick and gives the copper a brownish, orange color. Translating the reactive gas beam from the plasma source back and forth (2 passes) over the sample at a speed of 120 mm/s etches away the copper oxide and reveals the shiny copper metal underneath. The width of the etched away CuO strip is approximately 8.0 mm. In other embodiments, the spot plasma can be operated at RF power levels between 200 and 1,000 W, yielding power densities of 100 to 500 W/mm at the device exit. The distance from the device exit to the surface can range from 0.5 mm to 20 mm, and the translation speed can vary between 10 and 500 mm/s. A person skilled in the art will realize that the translation speed must be decreased if the power is decreased, or the offset increased, or the thickness of the CuO increased. By contrast, the translation speed can be increased if the temperature of the substrate is raised from 150 to 200° C. and beyond, because the reaction rate is thermally activated. Nevertheless, the speed that the copper oxide is etched away is surprisingly fast in this embodiment.

Modifications, additions, or omissions may be made to the systems, apparatuses, and methods described herein without departing from the scope of the disclosure. For example, in the appropriate context, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The foregoing description, including the preferred embodiment of the invention, has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A method for treating a surface of a material at atmospheric pressure, the method comprising:
providing an atmospheric pressure argon plasma source capable of delivering a beam comprising a reactive gas from the source outlet;
applying radio frequency (RF) power to the atmospheric pressure argon plasma source for generating the reactive gas in the beam from the source outlet; and
translating the atmospheric pressure argon plasma source relative to the material at a distance from the source outlet to said surface close enough for the reactive gas from the atmospheric pressure argon plasma source to contact and treat the surface;
wherein the beam of the reactive gas at the source outlet comprises a power density of at least 100 W/mm.

2. The method of claim 1, where the RF power has a frequency that is an integer multiple of 13.56 MHz.

3. The method of claim 2, where the frequency of the RF power is 27.12 MHz.

4. The method of claim 1, wherein the source outlet is a circular hole with a diameter between 0.5 and 2.0 mm.

5. The method of claim 1, wherein the RF power is at least 200 W.

6. The method of claim 1, wherein the atmospheric pressure argon plasma source generates the beam from a gas flow comprising argon and a molecular gas at a flow rate between 5 and 50 liters per minute.

7. The method of claim 6, wherein the gas flow further comprises argon and 1% of a molecular gas including molecules of O, N, and H.

8. The method of claim 6, wherein the gas flow further comprises argon and 1% of a molecular gas from the group consisting of oxygen (O₂), nitrogen (N₂), hydrogen (H₂) and mixtures thereof.

9. The method of claim 1, wherein translating the atmospheric pressure argon plasma source relative to the material is performed at a translation speed from 0 to 1,000 mm/s.

10. The method of claim 1, wherein the distance from the source outlet to the material surface is 0.5 to 25.0 mm.

11. The method of claim 1, wherein the material comprises one of a metal substrate, a semiconductor substrate, or a polymer substrate and contacting and treating the surface with the reactive gas from the atmospheric pressure argon plasma source comprises a material modification of the surface.

12. The method of claim 11, wherein the material modification is selected from the group consisting of cleaning, organic contamination removal, activation for adhesion improvement, etching, and metal oxide removal.

13. The method of claim 12, wherein the material surface comprises an organic polymer and the surface is cleaned and activated for adhesion by exposure to the atmospheric pressure argon plasma source fed with argon and oxygen.

14. The method of claim 12, wherein the material surface comprises glass and the surface is cleaned and activated by exposure to the atmospheric pressure argon plasma source fed with argon and oxygen.

15. The method of claim 12, wherein the material comprises an organic polymer and the organic polymer is etched away by exposure to the atmospheric pressure argon plasma source fed with argon and oxygen.

16. The method of claim 12, wherein the material comprises a metal and an oxide layer on the surface of the metal is removed by exposure to the atmospheric pressure argon plasma source fed with argon and hydrogen.

17. The method of claim 16, wherein the metal is selected from the group consisting of copper, tin, indium, silver, platinum, palladium, gold and mixtures thereof.
